(19) United States
(12) Patent Application Publication
(10) Pub. No.: US 2024/0271290 A1
(43) Pub. Date: Aug. 15, 2024

(54) METHOD AND APPARATUS FOR HYDROGEN PRODUCTION BY ELECTROLYSIS

(71) Applicant: BAR-ILAN UNIVERSITY, Ramat Gan (IL)

(72) Inventors: Doron Aurbach, Bnei Brak (IL); Eran Avraham, Petach Tikva (IL); Izaak Cohen, Petach Tikva (IL)

(21) Appl. No.: 18/112,614

(22) PCT Filed: Aug. 24, 2021
(86) PCT No.: PCT/IL2021/051036

§ 371 Date: Feb. 22, 2023

Related U.S. Application Data
(60) Provisional application No. 63/069,159, filed on Aug. 24, 2020.

(51) Int. Cl. C25B 1/04; C25B 9/63; C25B 11/043; C25B 11/046; C25B 15/08

(52) U.S. Cl. CPC C25B 1/04; C25B 9/63; C25B 11/043; C25B 11/046; C25B 15/08

(57) ABSTRACT

An electrochemical cell apparatus comprising: an electrolyte chamber and a positive electrode and a negative electrode disposed in the chamber; wherein a ratio between a surface area of the positive electrode and a surface area of the negative electrode is at least 100:1.

### DETAILS OF RELATED APPLICATIONS

This application claims benefit under 35 U.S.C. 119(e) of US provisional application 63/069,159 filed Aug. 24, 2020 and having the same inventors as the present application, which is fully incorporated herein by reference.

### FIELD OF THE INVENTION

The invention is in the field of hydrogen production by hydrolysis.

### BACKGROUND OF THE INVENTION

Hydrogen gas is considered as a clean energy carrier similar to electricity. Hydrogen can be used in batteries and in internal combustion engines to power vehicles or electric devices. In the long-term, hydrogen has the potential to reduce the dependence on foreign oil and/or to reduce the emission of greenhouse gases and other pollutants.

Hydrogen can be produced from various domestic resources, such as renewable energy and nuclear energy. Industrial hydrogen production can be divided into three main methods: steam reforming from hydrocarbons, electrolysis and thermolysis. The main method for hydrogen production from water is electrolysis. Successful electrolysis (or splitting) of water molecules must cross a thermodynamic voltage limit of 1.23 V at room temperature. However, extra energy is required to overcome energy losses that arise from activation energy, heat loss (for example, due to electrical resistance of the water), mass transport and kinetics phenomena, which raise the energy barrier of water electrolysis to above 3.5 V.

### SUMMARY OF THE INVENTION

A broad aspect of the invention relates production of hydrogen by hydrolysis One aspect of some embodiments of the invention relates to an electrochemical cell with a ratio between a surface area of the positive electrode and a surface area of the negative electrode of at least 80:1; at least 85:1; at least 90:1; at least 95:1; at least 100:1; at least 150:1; at least 175:1; at least 200:1; at least 500:1 or at least 1000:1 or intermediate or higher ratios. In some embodiments, this surface area ratio contributes to an ability to maintain a potential difference between the electrodes at 1.2 V or less; at 1.3 V or less; at 1.4 V or less; at 1.5 V or less; at 1.75 V or less; at 2.0 V or less; at 2.5 V or less or intermediate or lower voltages. In some exemplary embodiments of the invention, the positive electrode is grounded. According to various exemplary embodiments of the invention the positive electrode includes a carbon based material and/or a metal oxide. Alternatively or additionally, in some embodiments the negative electrode includes platinum and/or nickel and/or steel and/or high-area Ni steel and/or stainless steel and/or alloy(s). In some embodiments, at least a portion of the negative electrode is embedded in a carbon based material. Alternatively or additionally, in some embodiments the positive electrode comprises an intercalation compound. Intercalation compounds host atoms form a stationary framework in which guest ions occupy appropriate sites and move between accessible sites. During charging or discharging, electroactive ions are removed from or inserted into the host structure accompanied by the release or intake of electrons at the particular redox. The electrochemical performance of the intercalation compounds is highly dependent on their thermodynamic and kinetic properties. Carbon compounds (e.g. graphite, graphene and CNT) are the most common intercalation compounds for Chloride ions. In other exemplary embodiments of the invention, Mxenes such as metal carbides and metal sulfides (e.g. TiS₂) serve as intercalation compounds.

According to another aspect of some embodiments of the invention, a potential difference at 1.2 V or less; 1.3 V or less; 1.4 V or less; 1.5 V or less; 1.75 V or less; 2.0 V or less; 2.5 V or less or intermediate or lower voltages. is maintained between the electrodes while releasing hydrogen gas at the negative electrode of an electrochemical cell filled with electrolyte solution during hydrolysis. In some exemplary embodiments of the invention, the electrolyte solution includes a hydrogen donor such as HCl and/or H₂SO₄ and/or H₃PO₄ and/or HNO₃. Alternatively or additionally, in some embodiments the electrolyte solution contains dissolved salt in water. In some exemplary embodiments of the invention the positive electrode is removed from the solution, dried and replaced.

Still another aspect of some embodiments of the invention relates to periodically reducing and then re-increasing a concentration of electrolyte in an electrolyte solution during hydrolysis. For example, in some embodiments electrolysis beginning with an electrolyte concentration of X (e.g. 1M) which is then reduced to X/n, where n is 500, 1000, 2500, 5000, 10,000 or an intermediate or greater number. In some embodiments, this process is repeated cyclically.

Still another aspect of some embodiments of the invention relates to producing 1 Kg of hydrogen gas by electrolysis with an electric energy input of <30 kWh; <32 kWh; <34 kWh; <36 kWh; <38 kWh; <40 kWh; <42 kWh; <44 kWh; <46 kWh; <48 kWh; <50 kWh; <60 kWh or lesser or intermediate amounts of energy.

It will be appreciated that the various aspects described above relate to solution of technical problems associated with reducing the amount of energy required to produce each unit of hydrogen by electrolysis of an electrolyte in a solution relative to previously available alternatives.

Alternatively or additionally, it will be appreciated that the various aspects described above relate to solution of technical problems related to electrode recharging

In some exemplary embodiments of the invention there is provided an electrochemical cell apparatus including: (a) an electrolyte chamber; and (b) a positive electrode and a negative electrode disposed in the chamber; wherein a ratio between a surface area of the positive electrode and a surface area of the negative electrode is at least 100:1. In some embodiments, the positive electrode is surface treated with oxide functional groups. Alternatively or additionally, in some embodiments the apparatus includes a ground connection attached to the positive electrode. Alternatively or additionally, in some embodiments the positive electrode includes at least one material selected from the group consisting of activated carbon, graphene, graphene oxide, reduced graphene oxide, activated carbon with carbon dots, carbon nanotubes and metal oxide. Alternatively or additionally, in some embodiments the negative electrode includes at least one material selected from the group consisting of platinum, nickel, steel, high-area Ni steel, stainless steel, and alloys. Alternatively or additionally, in some embodiments the alloy includes at least one material selected from the group consisting of Ni—Mo, Co—Mo, Fe—Mo, Ni—V and Ni—W, and intermetallic phases of transition metals. Alternatively or additionally, in some embodiments the intermetallic phases of transition metals include at least one material selected from the group consisting of Zr—Pt, Nb—Pd, Pd—Ta, and Ti—Pt. Alternatively or additionally, in some embodiments at least a portion of the negative electrode is embedded in a material selected from the group consisting of graphite sheets, carbon cloth and carbon paper. Alternatively or additionally, in some embodiments the positive electrode includes an intercalation compound including at least one member of the group consisting of carbon compounds and Mxenes. Alternatively or additionally, in some embodiments the carbon compound is selected from the group consisting of graphite, graphene and CNT. Alternatively or additionally, in some embodiments the Mxene is selected from the group consisting of metal carbide and metal sulfide (e.g. TiS₂). Alternatively or additionally, in some embodiments the positive electrode includes redox electrodes. Alternatively or additionally, in some embodiments the apparatus includes a solution switching module including: a pump; at least two reservoirs for electrolyte solutions; and conduits and switches configured to cyclically switch solutions from the at least two reservoirs into and out of the electrolyte chamber. Alternatively or additionally, in some embodiments the apparatus includes a lifting mechanism attached to the positive electrode.

In some exemplary embodiments of the invention there is provided, a method including: (a) applying an electric current between a positive electrode and a negative electrode immersed in an electrolyte solution in an electrochemical cell; and (b) maintaining a potential difference ≤1.5 V between the electrodes while releasing hydrogen gas at the negative electrode. In some embodiments, the electrolyte comprises a hydrogen donor. Alternatively or additionally, in some embodiments the method includes: removing the positive electrode from the solution; drying the positive electrode; and placing the dry positive electrode back in the electrolyte solution. In some embodiments, this cycle is repeated iteratively. Alternatively or additionally, in some embodiments the method is least partially automated. Alternatively or additionally, in some embodiments the electrolyte comprises salt in water. Alternatively or additionally, in some embodiments the electrolyte is acidic. Alternatively or additionally, in some embodiments the electrolyte comprises HCl. Alternatively or additionally, in some embodiments the method includes periodically reducing and then re-increasing a concentration of the electrolyte in the electrolyte solution. Alternatively or additionally, in some embodiments the method includes beginning with at least 1 Molar electrolyte solution in the electrochemical cell; replacing the electrolyte solution with an electrolyte solution that is at least 500 times less concentrated; and cyclically repeating. Alternatively or additionally, in some embodiments the method is at least partially automated.

In some exemplary embodiments of the invention there is provided a method of producing hydrogen gas, including: (a) applying an electric current to an electrolyte solution in an electrochemical cell; and (b) releasing hydrogen gas at a negative electrode of the electrochemical cell; characterized in that an electrical energy input of ≤60 kWh produces 1 Kg of released hydrogen gas.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method. The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic illustration of an asymmetric electrochemical cell for producing hydrogen by electrolysis of HCl solution, according to an embodiment of the invention;

FIG. 2 is a schematic illustration of the faradaic reaction at the negative electrode and the capacitive reaction at the positive electrode during HCl electrolysis in an asymmetric electrochemical cell, according to an embodiment of the invention;

FIG. 3 is a schematic illustration of the voltage profile (voltage versus time) in an asymmetric electrochemical cell, according to an embodiment of the invention; In this Fig.: the dashed line represents the average voltage during the entire electrolysis process in the asymmetric electrochemical cell, while the solid lines represent the expected change in voltage during consecutive cycles of electrolysis;

FIG. 4 shows the voltage profile of an asymmetric carbon/platinum cell during 3 cycles of electrolysis of 0.1 M HCl with a current density of 10 mA/cm² (with respect to the platinum wire), according to an embodiment of the invention. In this Fig.: V is the electric potential in volts; T is time in seconds; a, b and c are the first, second and third cycle of H₂ evaporation, respectively;

FIG. 5 shows the voltage profile during electrolysis of 0.1 M HCl at the indicated current densities and at the indicated pH conditions in a cell with two identical platinum wires, according to an embodiment of the invention. In this Fig.: V is the electric potential in volts; T is time in seconds; a, b, c, d, e, f and g are pH values of 1, 3, 5, 7, 9, 11 and 13, respectively;

FIG. 6 shows the voltage profile during electrolysis of 0.1 M HCl at the indicated current densities and at the indicated pH conditions in an asymmetric platinum wire (cathode—the negative polarized electrode)/activated carbon (anode—the positive polarized electrode) cell, according to an embodiment of the invention. In this Fig.: V is the electric potential in volts; T is time in seconds; a, b, c, d, e, f and g are pH values of 1, 3, 5, 7, 9, 11 and 13, respectively; and

FIG. 7 shows a comparison between the voltage profile during electrolysis of 0.1 M HCl at the indicated current densities in a cell with two identical platinum wires at pH 1 (a) and an asymmetric platinum wire (cathode)/activated carbon (anode) cell, according to an embodiment of the invention at pH 1 (b) and pH 11 (c). In this Fig.: V is the electric potential in volts; T is time in seconds.

### DETAILED DESCRIPTION OF EMBODIMENTS

Embodiments of the invention relate to apparatus and methods for production of hydrogen by electrolysis.

Specifically, some embodiments of the invention can be used to produce hydrogen gas with a low energy input per unit of hydrogen relative to previously available alternatives.

The principles and operation of an electrochemical cell apparatus and/or method(s) according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Overview

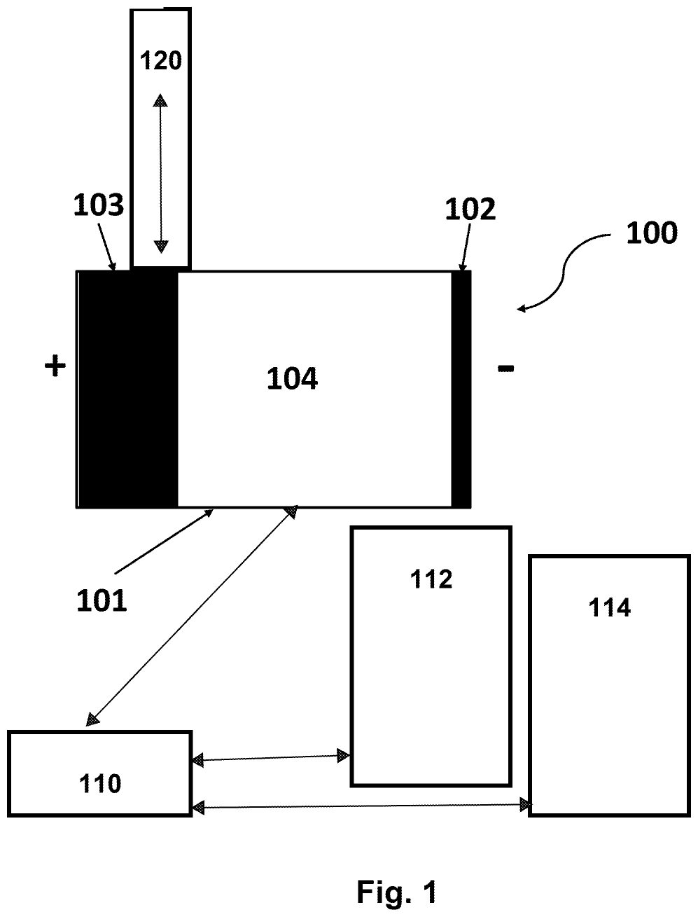

FIG. 1 is a schematic illustration of an asymmetric, typically single-compartment electrochemical cell apparatus 100 for producing hydrogen, according to one embodiment of the invention. The asymmetric electrochemical cell apparatus 100 includes a cell housing 101 adapted to contain at least one negative electrode 102 and at least one positive electrode 103 having a higher surface area than the negative electrode 102. In some exemplary embodiments of the invention, a ratio between the surface areas of the negative and positive electrodes is at least 1 to 100. An electrical circuit is formed when the negative electrode 102 and positive electrode 103 are immersed within a solution disposed within the cell housing 101 and electrically connected to a suitable power supply. The electrolyte solution 104 introduced to the asymmetric electrochemical cell 100 may contain any electrolyte. In some exemplary embodiments of the invention, the splitting of the electrolyte results directly or indirectly (through a series of reactions in the solution) in the formation of hydrogen gas in addition to, or instead of, hydrogen gas released from water in the solution.

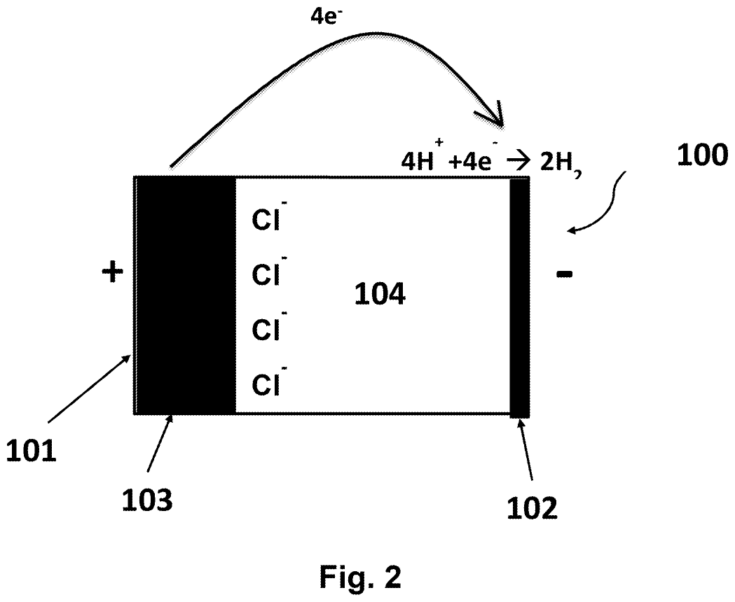

In a specific embodiment of the invention, the electrolyte is HCl. As shown in FIG. 2, when introducing an electrolyte solution 104 comprising HCl to the cell housing 101 and applying an electrical current between cathode 102 and anode 103, Cl⁻ anions are adsorbed to anode 103 in a capacitive reaction, while at cathode 102 electrons are transferred to H⁺ cations resulting in the production of hydrogen in a faradaic reaction according to the indicated equation.

### Exemplary Theoretical Considerations

Equation 1 defines the dependence of the differential between the surface area of the electrodes, the overall electric potential of the cell and the volume of the aqueous solution introduced into the apparatus on the amount of evaporated hydrogen gas which the apparatus may produce, as follows:

$$n ( {H}_{2} ) = ( ( ( ( [ {A}^{+} ] - [ {A}^{-} ] ) \times ε / d ) + {C}_{sd} ) \times g \times E ) / ( F \times 2 ) \qquad ( 1 )$$

wherein:
n(H₂) is the mole amount of evaporated hydrogen gas;
F is Faraday constant;
[A⁺] is the nominal surface area of the positive electrode;
[A⁻] is the nominal surface area of the negative electrode;
ε is the permittivity constant;
d is the distance between the surface adsorbed ions and the electrode's opposite charge in an electrical double layer;
C_{sd} is the total self-discharge capacity of the high surface area electrode;
g is a normalizing factor; and
E is the overall electric potential of the electrochemical cell.

It should be noted that the Cₛₐ is dependent on the specific material used for the high surface area electrode. Accordingly, the value of Cₛₐ should be determined for the specific anode material used in the device. Determining the value of Cₛₐ can be carried out using any routine method for measuring the self-discharge capacity of an electrode.

Every electrode has its own molecular structure, as well as specific physical and chemical properties, which during operation of an apparatus may lead to a deviation from the values that can be theoretically determined by an equation. Therefore, Equation 1 includes a normalizing factor (g), which takes the deviations into consideration. The normalizing factor is the average ratio between a theoretical surface area and an experimental surface area of a specific electrode. The normalizing factor is unique for a specific combination of high surface area and low surface area electrodes. The normalizing factor is obtained by the following steps:
(1) conducting a set of at least three experiments, in which an asymmetrical electrochemical cell is operated, wherein the surface area of a first electrode is different at each experiment (designated “experimental surface area”), while the surface area of the second electrode is constant through all experiments, as well as the volume and the content of the solution and the electric potential of the electrochemical cell; wherein the minimum time to operate the electrochemical cells in each experiment is the time required to charge the capacitor (the anode) to 95% of its maximum voltage;
(2) noting the resulting amount of evaporated H₂ at the end of each separate experiment;
(3) determining a theoretical surface area of the first electrode according to Equation 1, using the resulting amount of evaporated H_{2(g)} from the plurality of experiments, wherein g equals 1;
(4) determining the ratio between the theoretical surface area and the experimental surface area of the first electrode for each amount of obtained evaporated hydrogen (H₂) gas, from a separate experiment; and
(5) averaging the ratios between the theoretical surface area and the experimental surface area of the first electrode for each of the resulting amount of evaporated H₂, to obtain the normalizing factor for the specific combination of first and second electrodes as used in the experiment.

The time required to charge the capacitor to 95% of its maximum voltage is determined by Equation (2):

$${V}_{c} = {V}_{s} \times ( 1 - {e}^{- t / RC} ) \qquad ( 2 )$$

wherein:
V_{c} is the capacitor (anode) voltage;
Vₛ is the supply voltage;
t is the elapsed time since application of the supply voltage; and
RC is the time constant (Tau) of the charging circuit, in which:
   R is the total resistivity between the anode and cathode (encompassing capacitive, solution and electric resistivity); and
   C is the capacitance of the anode;

According to Equation 2, the time required to charge the anode to 95% of its maximum voltage is 3 times the time constant, namely, the value of 3×RC.

A method for selecting a ratio between the surface areas of electrodes in an asymmetric electrochemical cell device for producing hydrogen gas, comprising at least one positive electrode (anode) and at least one negative electrode (cathode), can be described as:
1. conducting a set of at least three experiments, using a different experimental surface area of a first electrode in an asymmetrical electrochemical cell and keeping the surface area of the second electrode, the volume and the content of the solution and the electric potential of the electrochemical cell constant;
2. measuring the amount of H₂ evaporated during each separate experiment;
3. determining a theoretical surface area of the first electrode according to Equation (1), wherein g equals 1, using the resulting amount of evaporated H₂(g) from said three or more experiments;
4. for each experiment, determining the ratio between the theoretical surface area and the experimental surface area of said first electrode; and
5. averaging the ratios between the theoretical surface area and the experimental surface area of the first electrode for each of said resulting amount of evaporated H₂, to obtain the normalizing factor for the specific combination of first and second electrodes as used in the experiment; and
6. determining the ratio A+/A− from Equation (1), using the value of (g) so obtained.

In one embodiment of the invention, the minimum time to operate the electrochemical cells in each experiment, as described in step (1) above, is the time required to charge the anode to 95% of its maximum voltage.

Practice of the above method guides a design engineer to implement a ratio between a surface area of the positive electrode and a surface area of the negative electrode of at least 100 to 1.

From thermodynamic point of view, water electrolysis (or splitting) for hydrogen production must cross a theoretical thermodynamic voltage limit of 1.23V at room temperature. In practice, extra energy is required to overcome energy losses from activation energy, heat losses (electrical resistance of the water for instance), mass transport and kinetics phenomenon. As a result, the actual energy barrier is typically above 3.5V.

In some exemplary embodiments of the invention, the energy barrier is reduced by reducing or eliminating release of oxygen from the water. In some embodiments, replacing the oxygen evolution electrode with a high surface area electrode contributes to a reduction in changes in potential of the electrode in response to the current between the two electrodes in the cell.

Alternatively or additionally, in some embodiments the high surface electrode strips off its accumulated charge without an external power (self discharging). Self discharging contributes to a reduction in voltage of the electrochemical cell during operation.

According to various exemplary embodiments of the invention self discharging is accomplished either by periodically removing and drying the electrode and/or grounding the electrode and/or surface treating the electrode with oxide functional groups.

In this way, the potential is the primary potential between the electrodes (OCV) which is significantly lower than 1.23 plus the overvoltage on the hydrogen evolution electrode.
The energy consideration is given bellow mathematically:
In general the total energy consumption from any electrochemical system is provided by equation [3]:

$$E = Δ Q \cdot V \qquad [ 3 ]$$

Where, E is the total consumed energy, Q is the charge passes in the process and V is the voltage between the electrodes.

For water electrolysis the total voltage is in accordance to equation [4]:

$$V = 1.23 + {η}_{{O}_{2}} + {η}_{{H}_{2}} \qquad [ 4 ]$$

Where η_{O}_{₂} and η_{H}_{₂} are the overvoltage for oxygen and hydrogen evolution, respectively. The over voltage, which is a function of the current density, can reach more than 2000 mV.

However, if the oxygen evolution electrode is replaced by a high surface area electrode (whereas the potential changes at this electrode are negligible according to

$$Δ V = \frac{Δ Q}{C}$$

where C is the capacitance and is very high (>100 F/g)), the total voltage is given by equation [5]

$$V = OCV + {η}_{{H}_{2}} \qquad [ 5 ]$$

However, the OCV can be made much smaller than 1.23 by appropriate surface treatment of the electrode. The total voltage, is therefore, governed, only by the over voltage for hydrogen evolution.

### Exemplary Surface Treatment of Electrodes

The functional groups used in surface treatment of electrodes can be classified into three categories: acidic, basic, and neutral.

Exemplary acidic functional groups include, but are not limited to, carboxylic acids and/or carboxylic anhydrides and/or lactones, and/or phenolic hydroxyls.

Basic functional groups are capable of binding with protons. Some oxygen containing functional groups such as chromenes and/or ketones and/or pyrones are basic by nature. Many nitrogen containing functional groups are also basic.

Functional groups like ketones, quinone and pyrones are in Equilibrium with ketone hydrate, hydroquinone and hydro-pyrones (not stable) in neutral pH. Theoretically, all functional groups are basic or acidic in some way. In some exemplary embodiments of the invention, negative charge/dipole functional groups contribute to the self-discharge of the positive electrode from negative ions.

In some exemplary embodiments of the invention, surface treatment is performed with the carbon of the electrode in dry phase. For example, in some embodiments, a reactant containing the desired functional group is purged in gas phase over the electrode at an appropriate temperature).

According to various exemplary embodiments of the invention temperature is selected based on the substance and the method used for the addition of functional groups. For example, when using ionized air for creation of ozone/peroxide/monoxide to oxidize the surface of the carbon to produce functional groups room temperature is appropriate. In other exemplary embodiments of the invention, up to 1000° C. is appropriate using weak oxidation/reduction agents.

In some exemplary embodiments of the invention, surface treatment is performed using wet chemistry to oxidize/reduce surface material of the solid electrode surface. For example, in some embodiments, a reactant containing the desired functional group is mixed with the electrode material in liquid phase.

According to various exemplary embodiments of the invention surface treatment of the electrode for induction of functional surface groups includes simple heat treatment of the electrode material in the presence of nitrogen or oxygen and/or reaction with ozone and/or reaction with nitric acid and/or reaction with hydrogen peroxide and/or reaction with ammonia and/or reaction with strong acids and/or reaction with strong bases and/or reaction with hot steam of water and/or treatment with plasma.

### Exemplary Operational Considerations

The high surface area positive electrode is easily regenerated by stripping off its accumulated charge. In some embodiments, regeneration of the positive electrode is continuous via a ground connection that allows the electrode to self-discharge. Alternatively or additionally, in some embodiments the positive electrode is surface treated with oxide functional groups. According to these embodiments, oxide functional groups on the surface of the high surface electrode provide a negative charge, so that the nominally positively polarized electrode exhibits enhanced self-discharge due to faradaic and electrostatic interactions, without any external intervention.

For purposes of this specification and the accompanying claims, the terms “oxide functional groups” and “oxygen-containing functional groups” (used interchangeably herein) refer to alcohols, ethers, aldehydes, ketones, and carboxylic acids, as well as to a variety of derivatives of the carboxylic acids, such as amides, esters, and acid halides. Non-limiting examples of oxide functional groups are carboxyl, lactone, lactol, phenol, ketone, carbonyl, and quinone groups.

Accordingly, the term “surface-treated positive electrode” as used herein refers to a positive electrode that is grounded and/or comprises oxide functional groups.

Hence, the total charge capacity gained by the enhanced self-discharge (Cₛₐ) of the surface-treated electrode (and/or grounded electrode), both in steady state and under application of a current density, is significantly improved and may approach infinity.

In some embodiments, regeneration of the anode is obtained by removing the electrode from the solution and drying it. The drying of the electrode can be achieved by wiping the electrode using a dry material having a moisture-absorbing surface (such as nonwoven papers and/or hygroscopic materials), by spontaneous drying at room temperature or by placing the electrode on a hot plate, until the electrode is dry. In a specific illustrative embodiment, the electrode is dried by placing it on a hot plate at 200° C.

Optionally, after removal of the electrode from the solution, it may be rinsed with water, e.g., tap water. In some exemplary embodiments of the invention, rinsing the electrode before drying contributes to a reduction in solidifications and/or crystallization of salt inside the nano porous infrastructure of the high surface area electrode. In embodiments that employ acids like HCl, H₂SO₄, H₃PO₄ and HNO₃ as electrolytes, rinsing of the anode is less important.

In some exemplary embodiments of the invention, the volume of the solution introduced into the electrochemical cell and/or the concentration of the electrolyte in the solution is replenished as necessary.

In some exemplary embodiments of the invention, the electrolyte introduced into the asymmetric electrochemical cell device is selected such that the splitting thereof results directly or indirectly (through a series of reactions in the solution) in the formation of hydrogen gas. According to one embodiment of the invention, the electrolyte is an aqueous solution. In a specific embodiment, the electrolyte is salt in water. According to another specific embodiment, the electrolyte is an acidic electrolyte, such as HCl and/or H₂SO₄ and/or H₃PO₄, and/or HNO₃.

In some embodiments, due to the higher surface area of the positive electrode compared to the negative electrode, applying electric current between the two electrodes results in:
a. adsorption of anions on the surface of the anode in a capacitive reaction; and
b. liberation of hydrogen gas from the solution following one or more faradaic reactions (depending on the specific electrolyte introduced into the device) at the cathode.

### Exemplary Apparatus

Referring again to FIG. 1, some embodiments of the invention relate to electrochemical cell apparatus 100 with an electrolyte chamber (depicted as housing 101) with a positive electrode 103 and a negative electrode 102 disposed in chamber 101. In the depicted embodiment, a ratio between a surface area of positive electrode 103 and a surface area of negative electrode 102 is at least 100:1. In some embodiments, this configuration is good for producing hydrogen gas with an operational voltage for the device less than 1.2 V. Alternatively or additionally, in some embodiments use of hydrogen donor electrolytes such as HCl, H₂SO₄, H₃PO₄ and HNO₃ in solution 104 contributes to a reduction in operational voltage.

In some exemplary embodiments of the invention, positive electrode 103 is surface treated with oxide functional groups as defined hereinabove. In some embodiments, these oxide functional groups contribute to an ability of the electrode to self-discharge.

In some exemplary embodiments of the invention, the apparatus includes a ground connection attached to positive electrode 103. In some embodiments, the ground connection contributes to an ability of electrode 103 to self-discharge.

In some exemplary embodiments of the invention, positive electrode 103 includes at least one material selected from the group consisting of activated carbon, graphene, graphene oxide, reduced graphene oxide, activated carbon with carbon dots, carbon nanotubes and metal oxide.

In some exemplary embodiments of the invention, positive electrode 103 includes an intercalation compound.

In some exemplary embodiments of the invention, positive electrode 103 includes redox electrodes. Redox electrodes are commonly used for sensitive measurement sensors with a life span based on the chemical and temperature conditions. Common redox electrodes for example: Hg/HgCl and Ag/AgCl. The potential of the electrodes is stable due to the steady layer of metal salt. In some exemplary embodiments of the invention, redox electrodes charge is used to remove anions instead of breaking the water into Oxygen at the positive electrode surface. According to these embodiments only the negative electrodes produce hydrogen, and the positive electrode surface covered by metal salt (e.g. AgCl, AgBr, HgCl and HgBr) until it reaches a limit of electrical resistance which stops the prosses until regeneration occurs. In some embodiments, negative electrode 102 includes at least one material selected from the group consisting of platinum, nickel, steel, high-area Ni steel, stainless steel, and alloys. According to various exemplary embodiments of the invention the alloy includes at least one material selected from the group consisting of Ni—Mo, Co—Mo, Fe—Mo, Ni—V and Ni—W, and intermetallic phases of transition metals. According to various exemplary embodiments of the invention the intermetallic phases of transition metals include at least one material selected from the group consisting of Zr—Pt, Nb—Pd, Pd—Ta, and Ti—Pt.

Alternatively or additionally, in some embodiments at least a portion of negative electrode 102 is embedded in a material selected from the group consisting of graphite sheets, carbon cloth and carbon paper.

Referring again to FIG. 1, the depicted exemplary apparatus includes a solution switching module 110. Switching modules 110 includes a pump and at least two reservoirs 112 and 114 for electrolyte solutions. Module 110 also includes conduits (depicted as double headed arrows) and switches configured to cyclically switch solutions from reservoirs 112 and 114 into and out of electrolyte chamber 101. In some embodiments, the pump and switches are coordinately controlled by an electronic control unit (not depicted). In some embodiments, the pump is a peristaltic pump.

In the depicted embodiment of FIG. 1, a lifting mechanism 120 is attached to positive electrode 103. In some exemplary embodiments of the invention mechanism 120 includes a vertical post attached electrode 103 and a drive train that moves electrode 103 up and down with respect to the post (Z-axis). According to various exemplary embodiments of the invention the drive train includes gears and/or pulleys and/or a belt drive and/or a chain and/or a ball screw.

### Exemplary Method

In some exemplary embodiments of the invention there is provided a method including applying an electric current between a positive electrode and a negative electrode immersed in an electrolyte solution in an electrochemical cell and maintaining a potential difference ≤1.5 V, (in some embodiments, ≤1.2 V) between the electrodes while releasing hydrogen gas at the negative electrode. In some exemplary embodiments of the invention, the electrolyte comprises a hydrogen donor. Examples of hydrogen donors include, but are not limited to HCl, H₂SO₄, H₃PO₄ and HNO₃.

In some embodiments, the method includes removing the positive electrode from the solution; drying the positive electrode; and placing the dry positive electrode back in the electrolyte solution. In some embodiments, the method includes rinsing the positive electrode with water prior to drying. In some exemplary embodiments of the invention, removing/drying the positive electrode periodically contributes to an ability to maintain the potential difference ≤1.2 V or another selected voltage limit. In some exemplary embodiments of the invention, the removing/drying/replacing is repeated iteratively.

Alternatively or additionally, in some embodiments the removing/drying/replacing is at least partially automated. In some exemplary embodiments of the invention, a controller operates a pump which removes the electrolyte solution from the electrochemical cell, while using air to take it out. In some embodiments, the air is heated to accelerate drying. Alternatively or additionally, in some embodiments the electrode is constructed of hydrophobic/superhydrophobic material to accelerate drying.

The controller then reverses the flow direction of the pump to return the electrolyte solution so that electrolysis can resume. In some embodiments, the system repeats the prosses until the user command it to stop.

In some exemplary embodiments of the invention, the electrolyte includes salt in water. Alternatively or additionally, in some embodiments the electrolyte is acidic. For purposes of this specification and the accompanying claims, the term “acidic” indicates a pH of 1 to 6. In some exemplary embodiments of the invention, the electrolyte includes HCl.

In some exemplary embodiments of the invention, the method includes periodically reducing and then re-increasing a concentration of the electrolyte in the electrolyte solution. In some embodiments, periodically reducing and then re-increasing a concentration of the electrolyte helps maintain the potential difference ≤1.2 V or another selected voltage limit.

In some exemplary embodiments of the invention, a relatively high concentration electrolyte solution is pumped out of the electrochemical cell and a relatively low concentration electrolyte solution is pumped into the electrochemical cell. The process is then reversed to return the relatively high concentration electrolyte solution to the electrochemical cell. In some embodiments, electric current is switched off during these solution changes.

In some embodiments, the method includes beginning with a least 1 Molar electrolyte solution in the electrochemical cell; replacing the electrolyte solution with an electrolyte solution that is at least 500 times less concentrated; and cyclically repeating. In some embodiments, the method is at least partially automated. In some embodiments, a controller uses two electrolyte solutions (highly concentrated and highly diluted with respect to salts), a pump, solenoids and electronic switches stop a current flow between the electrodes, pump the concentrated solution out of the electrochemical cell, refill the cell with diluted electrolyte solution, apply current between the electrodes for a predetermined time period, then stop the current flow between the electrodes, pump the diluted solution out of the electrochemical cell, refill the cell with concentrated electrolyte solution, apply current between the electrodes for a predetermined time period, and repeat the cycle. The duration of current application is a function of the differential between the concentrations of the two electrolyte solutions.

### Additional Exemplary Method

In some exemplary embodiments of the invention there is provided a method of producing hydrogen gas, including applying an electric current to an electrolyte solution in an electrochemical cell and releasing hydrogen gas at a negative electrode of the electrochemical cell; characterized in that an electrical energy input of ≤60 kWh produces 1 Kg of released hydrogen gas. According to various exemplary embodiments of the invention an electrical energy input of ≤58 kWh; ≤56 kWh; ≤54 kWh; ≤52 kWh; ≤50 kWh; ≤48 kWh; ≤46 kWh; ≤44 kWh; ≤42 kWh; ≤40 kWh; ≤38 kWh; ≤36 kWh; ≤34 kWh; ≤32 kWh; or ≤30 kWh or intermediate or lower amounts of energy produces 1 Kg of released hydrogen gas. The decrease of overall potential means the decrease of electrical energy. According to various exemplary embodiments of the invention in order to lower the overall potential at least the following factors should be considered:
In some embodiments, a surface area ratio between the electrodes directly affects the overall potential, which advance as logarithmic plot, but the higher the ratio is the bigger the electrochemical cell is. To optimize the overall potential with the size of the electrochemical cell it is recommended to reach a potential, which is close enough to the plateau of the logarithmic plot but permits use of a small enough electrochemical cell;
The electrolyte solution affects the overall potential used due to IR drop, which relates to the electrolyte concentration;
The concentration of protons in the electrolyte solution (i.e. use of acid), helps the encourage the faradaic reaction to work at lower potentials;

Higher solution temperature contributes to an increase in conductivity of the electrolyte solution which contributes to a reduction in the overall potential;
Working at low electric current slows the production of hydrogen, but lowers the overall potential used; and
Electrolyte solution flow rate contributes to the overall potential due to the refreshment of the solution next to the surface area of the electrodes, made by engineering of the flow regimes and turbulences.

### Exemplary Comparison to Conventional Electrolysis

In the conventional method of electrolysis, the operational voltage ranges between 2.5-3.5 V.

1 Kg of produced hydrogen (considering 100% charge efficiency) is equivalent to about 9*10\hat{ }7 columbs. According to E(J)=Vldt, 1 Kg of hydrogen requires between ˜55-90 kWh.

Considering the suggested technology, the energy should be cut off by about ½ (around 25 kWh), considering an operational voltage of 1-1.2V.

Even though some apparatus according to exemplary embodiments of the invention require a “relaxation time” of about 2 minutes to 3 minutes for 1 minute of operation, the projected hydrogen production should be at least 3 times to 5 times higher than a conventional electrolysis cells for any given plant capacity (Kg H₂/day).

In addition, it is possible to reduce the relaxation time duration and to mitigate the possibility of oxidation mixture with hydrogen production by dividing the operation of the system into two stages:
1st stage—Faradaic production of hydrogen at the negative electrodes, while accumulating charge on the surface area of the positive electrodes in a capacitive behavior, or by intercalation compounds in the electrodes.
2nd stage—changing the solution from high concentration to low concentration. Every order of magnitude between the different solutions increases the potential in about 59 mV, according to Nernst equation.

For example, if the 1st stage employs a 1 Molar solution (e.g. 1 M NaCl) and the 2nd stage employs a much lower salt concentration (i.e. 0.002 molar), the potential on the electrodes inside the system reactor will rise, without the use of an outside power source. The increased potential helps the positive electrodes to get rid of the charge, and rerun the 1st stage, while streaming to the system the 1 Molar salt concentration. In some exemplary embodiments of the invention, Na₂SO₄ is used instead of NaCl. In some embodiments, use of a chlorine free electrolyte contributes to a reduction in formation of chlorine gas at the capacitive/intercalation electrode.

The system can produce hydrogen continuously when using more than one reactor transferring high and low concentration electrolyte solutions back and forth between reactors (e.g. reactor A is in 1st stage while reactor B is 2nd stage then reactor A is in 2nd stage while reactor B is 1st stage).

It is expected that during the life of this patent many electrode materials will be developed and the scope of the invention is includes all such new technologies a priori.

Although the invention has been described in conjunction with specific embodiments thereof, it is evident that many alternatives, modifications and variations will be apparent to those skilled in the art. Accordingly, it embraces all such alternatives, modifications and variations that fall within the scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of hydrogen gas but might also be used to produce other gases.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

Additional objects, advantages, and novel features of various embodiments of the invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non-limiting fashion.

### Example 1

### The Electric Potential of the Asymmetric Electrochemical Cell Maintains a Constant Average Value Over Time

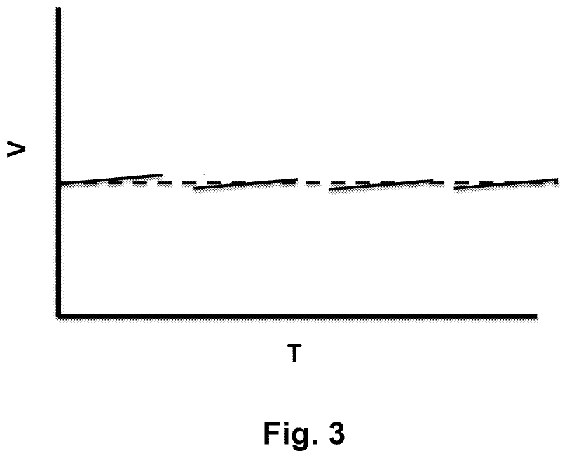

FIG. 3 is a schematic illustration of the voltage profile in an asymmetric electrochemical cell, according to one embodiment of the invention. The solid lines in the figure represent the expected change in voltage required to maintain a constant current between the electrode in the asymmetric electrochemical cell. The spaces between the solid lines represent the time of drying of the anode for reuse. During electrolysis, the voltage required in order to maintain a constant current between the electrodes increases over time, in part due to accumulation of charge on the anode. However, after regenerating the anode by drying and applying a second cycle of current in the cell, the voltage required for successful electrolysis is reduced to the starting point and rises again similar to the previous current cycle. The dashed line represents the average voltage during the entire electrolysis process, which is maintained constant due to the repetitive changes in voltage in each cycle.

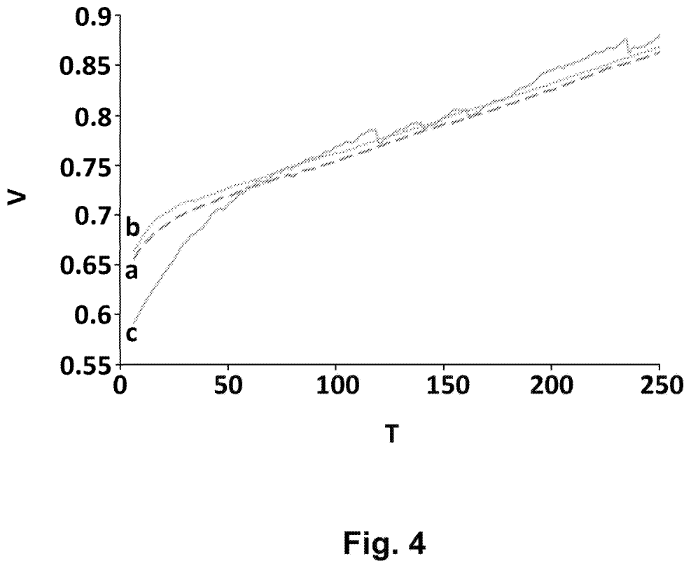

The voltage profile of a functional asymmetric electrochemical cell according to one embodiment of the invention during three cycles of electrolysis is shown in FIG. 4. A high surface area electrode cathode (Kynol activated carbon cloth (1500 m²/g) and platinum wire were clamped together with a glassy separator mounted in between. A current density of 10 mA/cm² was applied (with respect to the platinum wire), to the cell containing an electrolyte solution of 0.1 M HCl. After 250 seconds, the carbon electrode was taken out of the solution and was let to dry, using a hot plate set at 200° C. for 2 minutes. Afterwards, the carbon electron was mounted back in the cell and the same current density was applied to the cell. The results shown in FIG. 4 demonstrate a repetitive voltage profile for all current-drying cycles, namely, the electric potential during each of the cycles is similar to one another, thus maintaining a constant average value of voltage over time (as shown in FIG. 3).

### Example 2

### Total Voltage During Electrolysis is Drastically Reduced in the Asymmetric Electrochemical Cell Compared to a Symmetric Cell

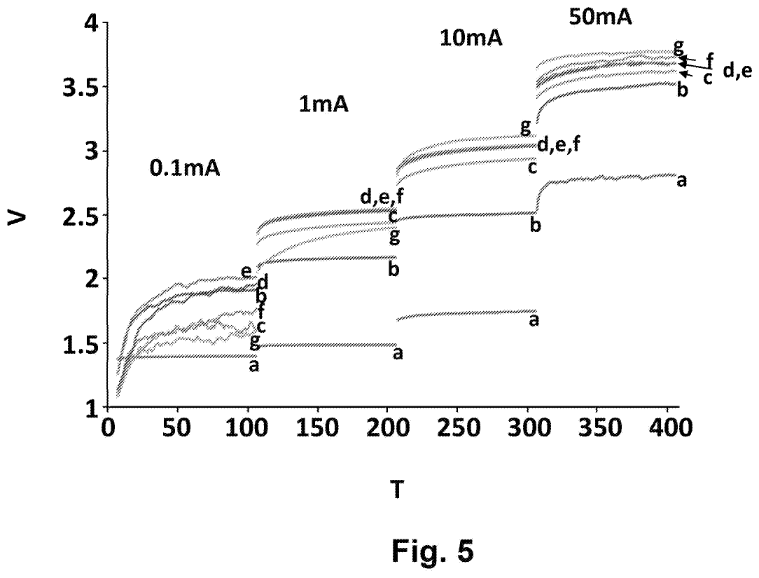

FIG. 5 shows the voltage profile of a symmetric electrochemical cell having two identical platinum wires as electrodes. The electrolytic solutions consisted of HCl or NaOH at a concentration which is appropriate to achieve a pH value of 1, 3, 5, 7, 9, 11 or 13 (designated a-g, respectively, in the figure). A current density of 0.1 mA, 1 mA, 10 mA or 50 mA was applied. As shown in FIG. 5, a solution at pH 1 requires the application of the lowest voltage for electrolysis for all given current densities.

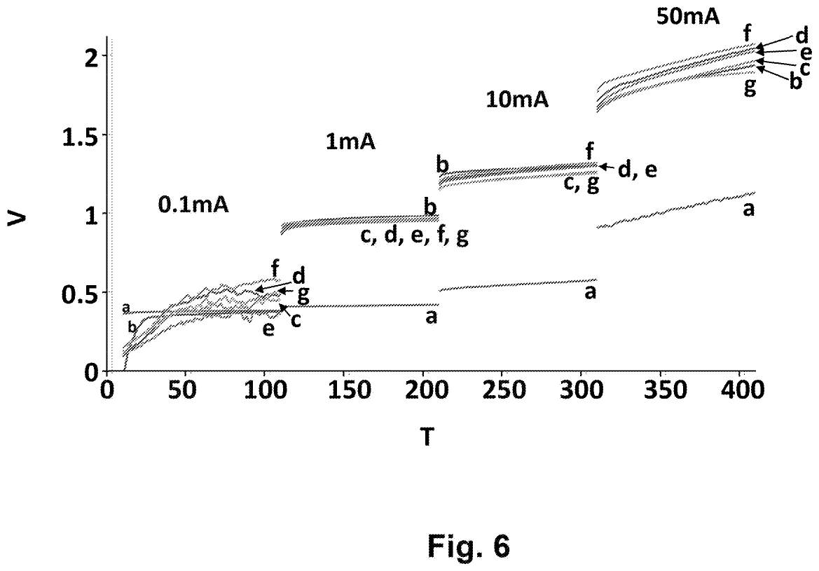

FIG. 6 shows the voltage profile of an asymmetric electrochemical cell having one platinum wire as the anode and a high surface area activated carbon electrode as a cathode. The electrolytic solutions and current densities applied were the same as described for FIG. 5 above. As shown in FIG. 6, while a solution at pH 1 requires the application of the lowest voltage for electrolysis, as solution at pH 11 requires the application of the highest voltage for electrolysis.

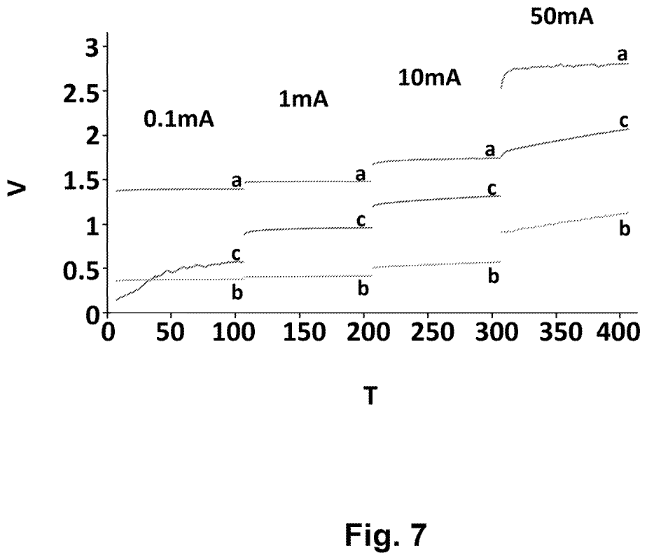

A comparison between the voltage profiles during electrolysis in the symmetric electrochemical cells and the asymmetric cell according to an embodiment of the invention reveals that even the highest voltage required for electrolysis of a solution at pH 11 in the asymmetric cell is still lower than the lowest voltage required for electrolysis of a solution at pH 1 in the symmetric cell (FIG. 7). Moreover, the voltage required for electrolysis of a solution at pH 1 using the asymmetric cell is drastically reduced compared to the voltage required for the same reaction in the symmetric cell. In addition, as shown in FIG. 7, the differences in the voltage profiles during electrolysis in the symmetric and asymmetric cells maintain their proportionality even at higher current densities.

1. An electrochemical cell apparatus comprising:
(a) an electrolyte chamber; and
(b) a positive electrode and a negative electrode disposed in said chamber;
wherein a ratio between a surface area of the positive electrode and a surface area of the negative electrode is at least 100:1.

2. An apparatus according to claim 1, wherein the positive electrode is surface treated with oxide functional groups.

3. An apparatus according to claim 2, comprising a ground connection attached to said positive electrode.

4. An apparatus according to claim 1, wherein the positive electrode comprises at least one material selected from the group consisting of activated carbon, graphene, graphene oxide, reduced graphene oxide, activated carbon with carbon dots, carbon nanotubes and metal oxide.

5. An apparatus according to claim 1, wherein the negative electrode comprises at least one material selected from the group consisting of platinum, nickel, steel, high-area Ni steel, stainless steel, and alloys.

6. (canceled)

7. An apparatus according to claim 5, wherein the alloy comprises at least one material group consisting of Ni—Mo, Co—Mo, Fe—Mo, Ni—V, and Ni—W, and intermetallic phases of transition metals, and the intermetallic phases of transition metals comprise at least one material selected from the group consisting of Zr—Pt, Nb—Pd, Pd—Ta, and Ti—Pt.

8. (canceled)

9. An apparatus according to claim 1, wherein the positive electrode comprises an intercalation compound including at least one member of the group consisting of carbon compounds and Mxenes.

10. (canceled)

11. An apparatus according to claim 9, wherein said Mxene is selected from the group consisting of metal carbide and metal sulfide (e.g. TiS₂).

12. An apparatus according to claim 1, wherein the positive electrode comprises redox electrodes.

13. An apparatus according to claim 1, comprising a solution switching module including:
a pump;
at least two reservoirs for electrolyte solutions; and
conduits and switches configured to cyclically switch solutions from said at least two reservoirs into and out of said electrolyte chamber.

14. An apparatus according to claim 1, comprising a lifting mechanism attached to said positive electrode.

15. A method comprising:
(a) applying an electric current between a positive electrode and a negative electrode immersed in an electrolyte solution in an electrochemical cell; and
(b) maintaining a potential difference ≤1.5 V between the electrodes while releasing hydrogen gas at the negative electrode.

16. A method according to claim 15, wherein said electrolyte comprises a hydrogen donor.

17. A method according to claim 15, comprising:
removing the positive electrode from the solution;
drying the positive electrode; and
placing the dry positive electrode back in the electrolyte solution.

18. A method according to claim 17, repeated iteratively.

19. (canceled)

20. The method according to claim 15, wherein the electrolyte comprises salt in water.

21. The method according to claim 15, wherein the electrolyte is acidic.

22. (canceled)

23. A method according to claim 15, comprising:
periodically reducing and then re-increasing a concentration of said electrolyte in said electrolyte solution.

24. A method according to claim 23, comprising:
beginning with at least 1 Molar electrolyte solution in said electrochemical cell;
replacing the electrolyte solution with an electrolyte solution that is at least 500 times less concentrated; and
cyclically repeating.

25. (canceled)

26. A method of producing hydrogen gas, comprising:
(a) applying an electric current to an electrolyte solution in an electrochemical cell;
(b) releasing hydrogen gas at a negative electrode of said electrochemical cell;
characterized in that an electrical energy input of ≤60 kWh produces 1 Kg of released hydrogen gas.
